(19) United States
(12) Patent Application Publication
(10) Pub. No.: US 2021/0192103 A1
(43) Pub. Date: Jun. 24, 2021

(54) OPTIMAL DESIGN METHOD FOR JET-TYPE SELF-PRIMING CENTRIFUGAL PUMP

(71) Applicant: JIANGSU UNIVERSITY, Jiangsu (CN)

(72) Inventors: Liang DONG, Jiangsu (CN); Qi PAN, Jiangsu (CN); Cui DAI, Jiangsu (CN); Houlin LIU, Jiangsu (CN); Minggao TAN, Jiangsu (CN); Yong WANG, Jiangsu (CN); Kai WANG, Jiangsu (CN); Xianfang WU, Jiangsu (CN)

(21) Appl. No.: 16/755,153

(22) PCT Filed: Oct. 31, 2017
(86) PCT No.: PCT/CN2017/108519

§ 371 Date: Apr. 9, 2020

(30) Foreign Application Priority Data
Oct. 18, 2017 (CN) 201710968463.0

(51) Int. Cl. G06F 30/17; G06F 30/28

(52) U.S. Cl. CPC G06F 30/17; G06F 2111/10; G06F 30/28

(57) ABSTRACT

An optimal design method for cutting at an impeller inlet provides a parameter selection and an optimal method for cutting lengths of a vertical side and a horizontal side, of the inlet, a diameter of the inclined position of the front and rear cover plates, the wall thickness δ1 of the front cover plate and the rear cover plate at an exit of the impeller after the inclination optimization, the number and wrap angle Φ of the long blades after optimization, an inlet diameter Dsi, arc length, axial offset degree, inclination angle, and the thickness of the splitter blades. The method is simple in implementation and can effectively improve the performance of the jet-type self-priming centrifugal pumps.

### TECHNICAL FIELD

The invention belongs to the research field of centrifugal pump, and specifically relates to an optimized design method of jet self-priming centrifugal pump. In particular, the invention relates to the optimization method of the impeller inlet, including tilt optimization setting on front cover and back cover of impeller, and Splitter blades are arranged between long blades.

### TECHNICAL BACKGROUND

As a general purpose machine, pump is mainly used to convert the mechanical energy of the original motor into the energy of liquid. It has been widely used in various sectors of the national economy and high-tech fields such as space ships. According to statistics, pumps account for 18% of the total power generation, so the energy saving potential is huge. For a jet self-priming centrifugal pump, the head when valve is closed should be considered in addition to the efficiency. The present invention improves the efficiency of the jet self-priming centrifugal pump by optimizing the impeller inlet and cover plate structure, and proposes a optimization design method of splitter blade to improve the head when valve is closed under the condition that the outer diameter of the impeller remains unchanged.

Upon retrieval, the present invention related patent applications are: “a complex variable curvature pump impeller design method of low specific speed reason, public number: CN103994099A splitter blade is used in the invention, the invention of the design is carried out for the splitter blade Angle, inclination Angle in (18°˜24°), within the scope of the blade Angle in (70°˜82°) range. The invention USES a fixed Angle range to select the parameters of sideling placed blade and scroll of blade. In addition, the invention published by zing shubing, zhu rongsheng, Yang ailing and others is named as [symbol] a design method of a long-blade rotary flow pump [symbol] . The public number is CN103541925A. the design of Splitter blades are made to improve the efficiency of rotary flow pump.

Comparing with the relevant patent, the invention intends to the selection of geometric parameters of the Splitter blades. The invention adopts inlet diameter of Splitter blades, length of Splitter blade, circumferential position deviation of Splitter blade, and inclination Angle parameters of Splitter blade. The invention uses the quantitative relation of geometric parameters between the Splitter blade and the long blade to determine the parameter range of the Splitter blade, so as to achieve the best effect. In addition, in order to further reduce pump Import energy loss and disc friction loss, the present invention proposes an optimization design method for pump inlet and front and rear cover plate by searching for related technologies that are not similar to the invention. The invention improves the performance of the original jet flow self-priming centrifugal pump by designing the geometric parameters above, and achieves the goal of improving the head, increasing the pump capacity and reducing the noise.

### THE INVENTION CONTENT

The purpose of the invention is to provide an optimal design method for the jet self-priming centrifugal pump in the light of such problems as large Import energy loss on the jet self-priming centrifugal pump, the dead point head can not raise when the impeller external diameter D₂ are fixed and the noise. Cutting at the impeller inlet, setting tilt of front cover and back cover, and optimal design of Splitter blade. The invention provides the cutting length of the vertical and horizontal sides called a, b. Pitch position diameter of front and rear cover plate called D. The thickness of the front cover plate and the back cover plate wall at the exit of the tilting optimized rear impeller called δ₁, The number of long blades after setting the splitter blade called Z₁, The scroll of long blade after optimized called Φ₁, The inlet diameter of the splitter blades called Dₛᵢ, The length of arc of split blades called S₂, The circumferential offset Angle of splitter blades called θ₁, The tilt Angle of splitter blades called a₂, and the parameter selection and optimization method of the thickness of the splitter blades. The invention is simple to implement and can effectively improve the performance of the jet self-priming centrifugal pump.

The technical scheme of the invention: an optimized design method of let self-priming centrifugal pump including the optimization of the impeller blade.

To optimize the impeller blade is to set splitter blades between the long blades of the pump including the choice of the number of blades Z, the long blade inclusion after optimized Φ₁, the inlet diameter of the splitter blades Dₛᵢ, the length of arc of split blades S₂, the circumferential offset angle of splitter blades θ₁ and the tilt angle of splitter blades a₂.

The relationship between the number of long blades on the optimized pump Z₂ and the number of long blades in the original pump Z₁ is as follows:

Z₂=Z′*Z₁ (5)

### Where

Z′ means the correction coefficient and Z′=0.6;

Optimized scroll of long blade Φ₁ and the original model of scroll of long blade Φ, original pump long blade number Z₁, optimized number of long blade on the pump Z₂ are satisfied the following equation:

Φ₁=Z₁Φ/K_{Φ}Z₂ (6)

### Where

K_{Φ} means the coefficient of the scroll of blade and K_{Φ}=0.9426;

The impeller inlet diameter of the splitter blades Dₛᵢ and the impeller outlet diameter D₂ are satisfied the following equation:

D′=Dₛᵢ/D₂ (7)

### Where

D′ means the correction coefficient and D=(0.4˜0.8)

The length of arc of split blades S, and the length of arc of long blades S₁ are satisfied the following equation:

K₅=S₂/S₁ (8)

### Where

K₅ means the correction coefficient and K₅=(0.4˜0.8)

The circumferential offset angle of splitter blades θ₁ and the angle between two adjacent long blades θ are satisfied the following equation:

K₆=θ₁/θ (9)

### Where

K₆ means the correction coefficient and K₆=(0.4˜0.6)

The tilt angle of splitter blades a₂ and the tilt angle of long blades a₁ are satisfied the following equation:

K₇=a₂/a₁ (10)

### Where

K₇ means the correction coefficient and K₇=(0.5˜0.9)

In particular, the inlet and outlet thickness of the splitter blades is consistent with that of the inlet and outlet thickness of the long blades.

And, the invention also includes cutting the impeller through the water side, further the vertical side cutting length a and the hub diameter of impeller dₕ are satisfied the following equation:

K₁=a/dₕ (1)

### Where

K₁ means the correction coefficient and K₁=(0.01˜0.05)

Moreover, the horizontal side cutting length b and the hub diameter of impeller dₕ are satisfied the following equation:

K₂=b/dₕ (2)

### Where

K₂ means the correction coefficient and K₂=(0.02˜0.08)

The impeller front shroud and the impeller back shroud were designed by tilting, It Includes the design of the pitch position diameter Dₜ. And the design of the pitch position diameter of the impeller front shroud and the impeller back shroud Dₜ and the impeller outlet diameter D₂ are satisfied the following equation:

K₃=Dₜ/D₂ (3)

### Where

K₃ means the correction coefficient and K₃=(0.75˜0.95)

Also, the design of tilting includes the thickness of the impeller front shroud and the impeller back shroud by this way, the optimized thickness of the impeller front shroud and the impeller back shroud δ₁ and the original thickness of the impeller front shroud and the impeller back shroud δ₂ are satisfied the following equation:

K₄=δ₁/δ₂ (6)

### Where

K₄ means the correction coefficient and K₄=(0.6˜0.9)

That mentioned above, The calculated result of the optimized number of long blade on the pump Z₂ is taken upward. It is worth noting that the number of long blades on the optimized pump Z₂ is equal to the number of splitter blades Z₃

Compared with the existing technology, the beneficial effect of the invention:
1. The invention improves the performance of the pump by adding splitter blades between the long blades of the pump, thus improving the efficiency of the pump and improving the pump head.
2. It is well known that when the liquid passes through the inlet side of the impeller, it will produce shock and then impact loss. In order to reduce the loss, the invention cuts the inlet side of the impeller to make it a buffer zone, so that the loss is much smaller when the liquid flows through this area, which can effectively reduce the impact loss of the inlet.
3. The invention includes impeller front shroud and the impeller back shroud were designed by tilting so that the disc friction loss at the front and rear cover of the impeller can be reduced without changing the outside diameter of the impeller.
4. Compared with the performance of the 800 w jet self-suction centrifugal pump before and after optimization, It's clear that the efficiency and the head of the pump is improved without exceeding the rated power after the optimized design, The invention increases the head of the original pump to 131.23 ft, the flow rate to 3600 L/H, the rotating speed to n=2995 r/m, the efficiency to 17.2%, and the noise to 78 dB by geometric parameter optimization. The invention realizes hydraulic optimization of impeller on the jet self-priming centrifugal pump with current rated power of 800 w.

### THE APPENDED DRAWINGS

FIG. 1 is a leaf wheel axle diagram of the invention and an enlarged view of the cutting at the inlet of the impeller.

FIG. 2 is the impeller plan of the original model

FIG. 3 is the impeller plan of the optimized model

FIG. 4 is the performance curve of the original model pump of the invention

FIG. 5 shows the performance curve of the optimized model pump

In the diagram, 1 means impeller inlet; 2 means impeller front shroud; 3 means impeller back shroud; 4 means splitter blades; 5 means long blade of the original model; 6 means long blade of the Optimized model.

### IMPLEMENTATION OF THE EASE

Further details of the invention are given below in combination with attached drawings and specific implementation cases, but the scope of protection of the invention is not limited.

The invention relates to an optimized design method for a jet self-priming centrifugal pump which includes the optimization of the inlet 1, the impeller front shroud 2, the impeller hack shroud 3 and the blades.

when the liquid passes through the inlet side of the impeller, it will produce shock and then impact loss. In order to reduce the loss, the invention cuts the inlet side of the impeller to make it a buffer zone, so that the loss is much smaller when the liquid flows through this area, which can effectively reduce the impact loss of the inlet.

In order to make the inlet into the desired buffer zone, the cutting scheme adopted in the invention is that we select the appropriate cutting length on both sides (the vertical side and the horizontal side) of the inlet, the cutting length of the vertical sides called a, and the cutting length of the horizontal sides called b. And, the vertical side cutting length a and the horizontal side cutting length b is determined by the quantitative relation between a, b and the huh diameter the hub diameter of impeller dₕ, and they are satisfied the following equation:

K₁=a/dₕ (1)

dₕ is the hub diameter of impeller, mm

K₁ means the correction coefficient and K₁=(0.01˜0.05)

K₂=b/dₕ (2)

K₂ means the correction coefficient and K₂=(0.02˜0.08)

When the impeller rotates, there is friction loss between the outer surface of the front shroud and the hack shroud of the impeller and the liquid by the rapid rotating speed of the impeller. The loss is related to the diameter of the impeller, which is called disk friction loss. The invention optimizes the tilting design of the front shroud and the back shroud of the impeller so as to reduce the friction loss without changing the outside diameter of the impeller.

For setting the slant optimization parameters of the front shroud and the back shroud of the impeller, in the first, the invention determines the pitch position diameter Dₜ, and then determines the optimized thickness of the impeller front shroud and the impeller back shroud δ₁. When these two parameters are determined, the slant design of the front shroud and the back shroud cover plate is also determined.

For selecting the pitch position diameter Dₜ, the invention establishes a quantitative relation with the impeller outlet diameter D₂:

K₃=Dₜ/D₂ (3)

K₃ means the correction coefficient and K₃=(0.75˜0.95)

Therefore, in the case that the impeller outlet diameter is known as D₂, the pitch position diameter Dₜ can be determined by the correction coefficient K₃.

For the selection of the parameters of the optimized thickness of the impeller front shroud and the impeller back shroud δ₁, the present invention establishes the δ₁ and the original thickness of the original thickness of the impeller front shroud and the impeller back shroud δ₂ to a quantitative relationship, and they are satisfied the following equation:

K₄=δ₁/δ₂ (4)

K₄ means the correction coefficient and K₄=(0.6˜0.9)

Therefore, δ₁ can be determined by the correction coefficient K₄ when the δ₂ is known.

What optimizes the impeller blades is that the splitter blades are arranged between the long blades of the original model the invention includes the choice of the number of blades Z, the scroll of long blade after optimized Φ₁, the inlet diameter of the splitter blades Dₛₗ, the length of arc of splitter blades S₂, the circumferential offset angle of splitter blades θ₁, the tilt angle of splitter blades a₂, and the optimized thickness of splitter blades at the inlet and outlet.

The design method of setting splitter blades between long blades is adopted to increase the head when the valve is completely closed and reduce the blockage at the inlet of the impeller. The methods adopted are as follows:

With the increase of blade number of impeller, the head increases obviously. However, too many blades will cause a large amount of hydraulic friction loss, which, on the contrary, reduces the efficiency of the pump. At the same time, the increase of the number of blades will lead to the increase of power, so it is particularly important to select an appropriate number of blades Z, In order to change the outside diameter and not overpower, a new method of adding splitter blades is proposed. A quantitative relationship was established between original pump long blade number Z₁ and optimized number of long blade on the pump Z₂, the relation is used to determine the optimized number of blades Z₂. The expression is set up as follows:

Z₂=Z′*Z₁ (5)

Z′ means the correction coefficient and Z′=0.6;

The calculated result of Z₂ is taken upward. Since the number of the splitter blade is equal to Z2, Z3 can be determined when Z2 is known.

In order to determine the optimized scroll of long blade Φ₁, optimized scroll of long blade Φ₁ and the original model of scroll of long blade Φ, original pump long blade number Z₁, optimized number of long blade on the pump Z₂ are adopted to establish a quantitative relationship:

Φ₁=Z₁Φ/K_{Φ}Z₂ (6)

K_{Φ} means the coefficient of the scroll of blade and K_{Φ}=0.9426;

So after the known Φ, Z₁ and the Z2 calculated by Z′,Φ₁ can be determined. The impeller inlet diameter of the splitter blades Dₛᵢ relates to the length of the splitter blades. Theoretically speaking, the longer the blade length is, the bigger the head, However, it can be seen from the study that the inlet will be blocked and the head will be reduced because of the too long splitter blades, which will also lead to a decrease in efficiency. But, if the splitter blade is too short it will not improve the structure of jet—wake at the outlet and improve the efficiency of the pump. Therefore, the quantitative relation between the impeller inlet diameter of the splitter blades Dₛᵢ and the impeller outlet diameter D₂ is proposed to determine Dₛᵢ, they are satisfied the following equation:

D″=Dₛᵢ/D₂ (7)

D′ means the correction coefficient and D′=(0.4˜0.8)

So you can determine Dₛᵢ by D″ when you know D₂.

When choosing the parameters of the length of arc of split blades S₂, a quantitative relationship between the length of arc of splitter blades S₂ and the length of arc of long blades S₁ is proposed. The relationship is as follows:

K₅=S₂/S₁ (8)

K₅ means the correction coefficient and K₅=(0.4˜0.8)

So you can determine S₂ by K₅ when you know S₁.

According to the flow slip theory in the centrifugal pump, the velocity distribution in the impeller passage is not uniform, so the splitter blade cannot be arranged in the middle of the flow passage, and it needs to be offset to the back of the long blade, which is conducive to improving the “jet-wake” structure at the outlet and improving the performance of the pump. The invention determines the circumferential position of the splitter blade by the ratio of the circumferential offset Angle of splitter blades θ₁ to the angle between two adjacent long blades θ, and the relationship is as follows:

K₆=θ₁/θ (9)

K₆ means the correction coefficient and K₄=(0.4˜0.6)

So you can determine θ₁ by K₆ when you know θ, and the circumferential offset position of the splitter blade can be determined.

The tilting position of the splitter blade can be determined by the tilt angle of splitter blades a₂, so the quantization relationship is established by the tilt angle of splitter blades a₂ and the tilt Angle of long blades a₁:

K₇=a₂/a₁ (10)

K₇ means the correction coefficient and K₇=(0.5˜0.9)

The invention designs the inlet and outlet thickness of the splitter blade. For the invention, the inlet and outlet thickness of the splitter blade is consistent with the long blade.

The implementation process of the invention is illustrated by taking low specific speed Jet self-priming centriftigal pump as an example. And the specific parameters of the pump are as follows: rated power is 800 w, specific speed is 32, head H is 121.39 ft, mass flow rate Q is 3700 L/H, speed n is 2775 r/m, efficiency η is 14.3%, impeller diameter D₂ is 121 mm, width of blade outlet b₂ is 4 mm, the original model of scroll of long blade Φ is 100°, blade inlet angle β₁ is 19.3°, blade outlet angle β₂ is 35°, the hub diameter the hub diameter of impeller dₕ is 19 mm, number of blades Z is 6, the original thickness of the impeller front shroud and the impeller back shroud δ₂ is 2 mm.

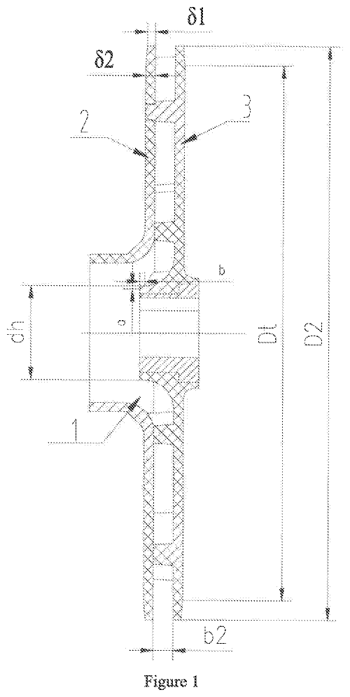

As is shown in FIG. 1, the liquid passes through the inlet side of the impeller 1, it will produce shock the cutting scheme adopted in the invention is that we select the appropriate cutting length on both sides (the vertical side and the horizontal side) of the inlet to make it a buffer zone, and the cutting length of the vertical sides called a, and the cutting length of the horizontal sides called b. The diameter of the impeller hub dₕ is 19.2 mm, so you can figure out what a and b are by using (1) and (2). In this design, k₁ and k₂ were selected by CFD numerical calculation, after the numerical calculation, k₁=0.02, k₂=0.03, a=0.4 mm and b=0.6 mm.

From FIG. 1, the invention includes impeller front shroud 2 and the impeller back shroud 3 were designed by tilting. And D₂=117 mm, we determine the modified coefficient k₃ by CFD numerical calculation, after the numerical calculation, K₃=0.932, Therefore, the pitch position diameter Dₜ is calculated by (3). As a result, Dₜ=109 mm.

From FIG. 1, the original thickness of the impeller front shroud and the impeller back shroud δ₂ is 2 mm, we determine the modified coefficient k₄ by CFD numerical calculation, after the numerical calculation, K₄=0.75. Therefore, the optimized thickness of the impeller front shroud and the impeller back shroud δ₁ is calculated by (4). As a result, δ₁=1.5 mm.

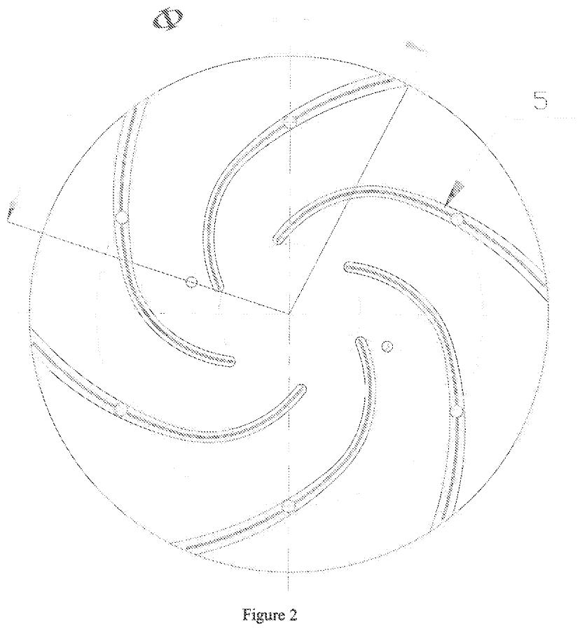

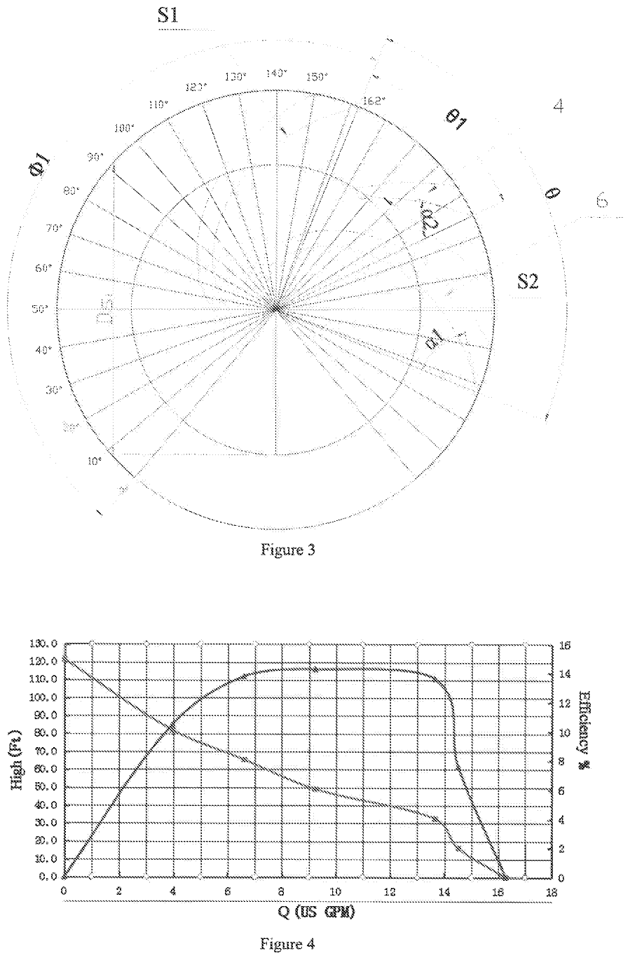

From FIG. 2, the original pump long blade number Z₁ is 6, and from FIG. 3, you can get the optimal method of the splitter blade. The optimized number of long blade on the pump Z₂ is calculated by (5). As a result, Z₂=4, the calculated result of Z₂ is taken upward, further Z₃=4.

From FIG. 2, the original model of scroll of long blade 5 Φ is 100° and Z₁=6, Z₂=4. So the optimized scroll of long blade 6 Φ₁ is calculated by (6). As a result, Φ₁=162°.

From FIG. 3, you can determine the impeller inlet diameter of the splitter blades Dₛᵢ by (7). And the impeller outlet diameter D₂ is 117 min, we determine the modified coefficient D′ by CFD numerical calculation, after the numerical calculation, D′=0.72, Therefore, Dₛᵢ can be calculated by (7). As a result, Dₛᵢ=84.2 mm.

From FIG. 3, the length of arc of long blades S₁ is 64 mm, and we determine the modified coefficient K₅ by CFD numerical calculation, after the numerical calculation, K₅=0.6. Therefore, the length of arc of split blades S₂ can be calculated by (8). As a result, S₂=38.5 mm.

From FIG. 3, the angle between two adjacent long blades θ is 72°, the modified coefficient K₆ can be calculated by CFD numerical calculation, after the numerical calculation, K₆=0.4. Therefore, the circumferential offset angle of splitter blades θ₁ can be calculated by (9). As a result, θ₁=28.8°.

From FIG. 3, the tilt angle of long blades a₁ is 55°, the modified coefficient K₇ can be calculated by CFD numerical calculation, after the numerical calculation, K₇=0.8. Therefore, the tilt angle of splitter blades a₂ can be calculated by (10). As a result, a₂=44°.

The inlet and outlet thickness of the splitter blade is consistent with the long blade in the invention. And the thickness of the inlet of the splitter blade is 3 mm, the thickness of the outlet of the splitter blade is 7 mm, the thickness in the middle of the splitter blade is 53 mm.

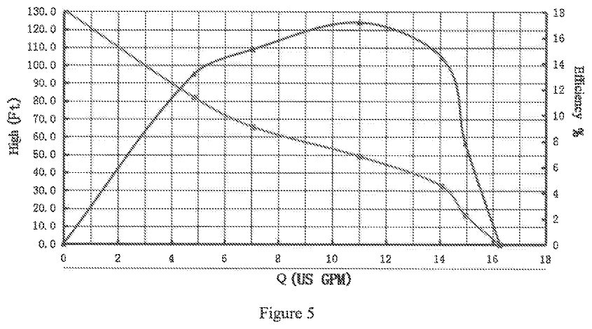

As is shown in awe 4, we can see the performance curve of the original model of jet self-priming centrifugal pump, and the FIG. 5 shown that the performance curve of the optimized jet self-priming centrifugal pump. Comparing to two figure, it can be clearly seen that the flow-head curve drops sharply after the optimization. As a result, the pump efficiency is improved and the head is raised without exceeding the rated power. We optimize the pump by the above geometric parameters, as a result, the head was increased to 131.23 ft, the mass flow rate Q becomes 3600 L/H, the rotating speed n up to 2995 r/m, the efficiency was increased to 17.2%, and the noise was reduced to 78 dB. The impeller optimization is completed on the jet self-priming centrifugal pump with rated power of 800 w.

1: An optimized design method of jet self-priming centrifugal pump, it includes the optimization of the impeller blade
to optimize the impeller blade is to set splitter blades between the long blades of the pump including the choice of the number of blades Z, the long blade inclusion after optimized Φ₁, the inlet diameter of the splitter blades Dₛᵢ, the length of arc of split blades S₂, the circumferential offset angle of splitter blades θ₁ and the tilt angle of splitter blades a₂;
the relationship between the number of long blades on the optimized pump Z₂ and the number of long blades in the original pump Z₁ is as follows:
Z₂=Z′*Z₁ (5)
where
Z′ is the correction coefficient and Z′=0.6;
optimized scroll of long blade Φ₁ and the original model of scroll of long blade Φ, original pump long blade number Z₁, optimized number of long blade on the pump Z₂ are satisfied the following equation:
Φ₁=Z₁Φ/K_{Φ}Z₂ (6)
where
K_{Φ} is the coefficient of the scroll of blade and K_{Φ}=0.9426;
the impeller inlet diameter of the splitter blades Dₛᵢ and the impeller outlet diameter D₂ are satisfied the following equation:
D′=Dₛᵢ/D₂ (7)
where
D′ is the correction coefficient and D′=(0.4˜0.8)
the length of arc of split blades S₂ and the length of arc of long blades S₁ are satisfied the following equation:
K₅=S₂/S₁ (8)
where
K₅ is the correction coefficient and K₅=(0.4˜0.8)
the circumferential offset angle of splitter blades θ₁ and the angle between two adjacent long blades θ are satisfied the following equation:
K₆=θ₁/θ (9)
where
K₆ is the correction coefficient and K₆=(0.4˜0.6)
the tilt angle of splitter blades a₂ and the tilt angle of long blades a₁ are satisfied the following equation:
K₇=a₂/a₁ (10)
and where
K₇ is the correction coefficient and K₇=(0.5˜0.9).

2: The optimal design method of the jet self-priming centrifugal pump according to claim 1, wherein the inlet and outlet thickness of the splitter blades is consistent with that of the inlet and outlet thickness of the long blades.

3: The optimal design method of the jet self-priming centrifugal pump according to claim 1, further including cutting the impeller through the water side, wherein the vertical side cutting length a and the hub diameter of impeller dₕ are satisfied the following equation:
K₁=a/dₕ (1)
where
K₁ is the correction coefficient and K₁=(0.01˜0.05).

4: The optimal design method of the jet self-priming centrifugal pump according to claim 3, further including cutting the impeller through the water side, wherein, the horizontal side cutting length b and the hub diameter of impeller dₕ are satisfied the following equation:
K₂=b/dₕ (2)
where
K₂ is the correction coefficient and K₂=(0.02˜0.08)

5: The optimal design method of the jet self-priming centrifugal pump according to claim 1, wherein the impeller front shroud and the impeller back shroud were designed by tilting, it includes the design of the pitch position diameter Dₜ, and the design of the pitch position diameter of the impeller front shroud and the impeller back shroud Dₜ and the impeller outlet diameter D₂ are satisfied the following equation:
K₃=Dₜ/D₂ (3)
where
K₃ is the correction coefficient and K₃=(0.75˜0.95).

6: The optimal design method of the jet self-priming centrifugal pump according to claim 5, wherein the design of tilting includes the thickness of the impeller front shroud and the impeller back shroud, by this way, the optimized thickness of the impeller front shroud and the impeller back shroud δ₁ and the original thickness of the impeller front shroud and the impeller back shroud δ₂ are satisfied the following equation:
K₄=δ₁/δ₂ (4)
where
K₄ is the correction coefficient and K₄=(0.6˜0.9).

7: The optimal design method of the jet self-priming centrifugal pump according to claim 1, wherein the result of the optimized number of long blade on the pump Z₂ calculated by the correction coefficient Z′ and the number of long blades in the original pump Z₁ is taken upward.

8: The optimal design method of the jet self-priming centrifugal pump according to claim 7, wherein the number of long blades on the optimized pump Z₂ is equal to the number of splitter blades Z₃.
